(19) United States
(12) Patent Application Publication
(10) Pub. No.: US 2014/0289419 A1
(43) Pub. Date: Sep. 25, 2014

(54) SYSTEM, METHOD AND COMPUTER PROGRAM PRODUCT FOR TRANSFERRING A WEBSITE STATE ACROSS USER DEVICES USING A COOKIE

(71) Applicant: salesforce.com, inc., San Francisco, CA (US)

(72) Inventor: Amit Vijayant, Belmont, CA (US)

(73) Assignee: salesforce.com, inc., San Francisco, CA (US)

(21) Appl. No.: 14/158,736

(22) Filed: Jan. 17, 2014

Related U.S. Application Data
(60) Provisional application No. 61/804,541, filed on Mar. 22, 2013.

(51) Int. Cl. H04L 29/06

(52) U.S. Cl. CPC H04L 65/1069
USPC 709/227

(57) ABSTRACT

In accordance with embodiments, there are provided mechanisms and methods for transferring a website state across user devices using a cookie. These mechanisms and methods for transferring a website state across user devices using a cookie can use the cookie provide sharing of browser information among the user devices. The ability to provide sharing of browser information via a cookie can enable a user of one device to access the state of a browsing session with a website performed on another device, with minimal involvement by a backend system.

### CLAIM OF PRIORITY

This application claims the benefit of U.S. Provisional Patent Application No. 61/804,541 entitled “System and Method for Single User Authentication Across Multiple Domains,” by Amit Vijayant, filed Mar. 22, 2013 (Attorney Docket No. 1125PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to sharing browser information across devices.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the past, browser information has been capable of being shared across separate devices via a backend system, However, the backend system has conventionally functioned to synchronize with the device browsers, such that the backend system has proactively stored the browser information of the devices for sharing purposes. This has required substantial storage capacity by the backend system, and further causes security concerns where the browser information may not always be desired to be shared.

Accordingly, it is desirable to provide techniques enabling the sharing of browser information across separate devices, with minimal involvement by a backend system.

### BRIEF SUMMARY

In accordance with embodiments, there are provided mechanisms and methods for transferring a website state across user devices using a codkie, These mechanisms and methods for transferring a website state across user devices using a cookie can enable embodiments to use the cookie provide sharing of browser information among the user devices. The ability of embodiments to provide sharing of browser information via a cookie can enable a user of one device to access the state of a browsing session with a website performed on another device, with minimal involvement by a backend system.

In an embodiment and by way of example, a method for transferring a website state across user devices using a cookie is provided. In use, a request is received from a first browser of a first device of a user, where the request is for a state of a website on a second browser of a second device of the user. Additionally, the requested state is received by a backend system from the second device of the user, utilizing a cookie having the requested state that is stored by the second browser of the second device of the user. Further, the requested state is transmitted from the backend system to the first device of the user.

While one or more implementations and techniques are described with reference to an embodiment in which transferring a website state across user devices using a cookie is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for transferring a website state across user devices using a cookie, in accordance with an embodiment;

FIG. 2 illustrates a system for transferring a website state across user devices using a cookie, in accordance with an embodiment;

FIG. 3 illustrates a method for using a first device of a user to initiate a browsing session with a website, in accordance with an embodiment;

FIG. 4 illustrates a method for using a second device of the user to access the browsing session of the first device of the user, in accordance with the method of FIG. 3;

FIG. 5 illustrates a method for using a backend system to facilitate the sharing of browser information across user devices, in accordance with the methods of FIGS. 3-4;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are pr vided for transferring a website state across user devices using a cookie.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing transferring a website state across user devices using a coolie will be described with reference to example embodiments,

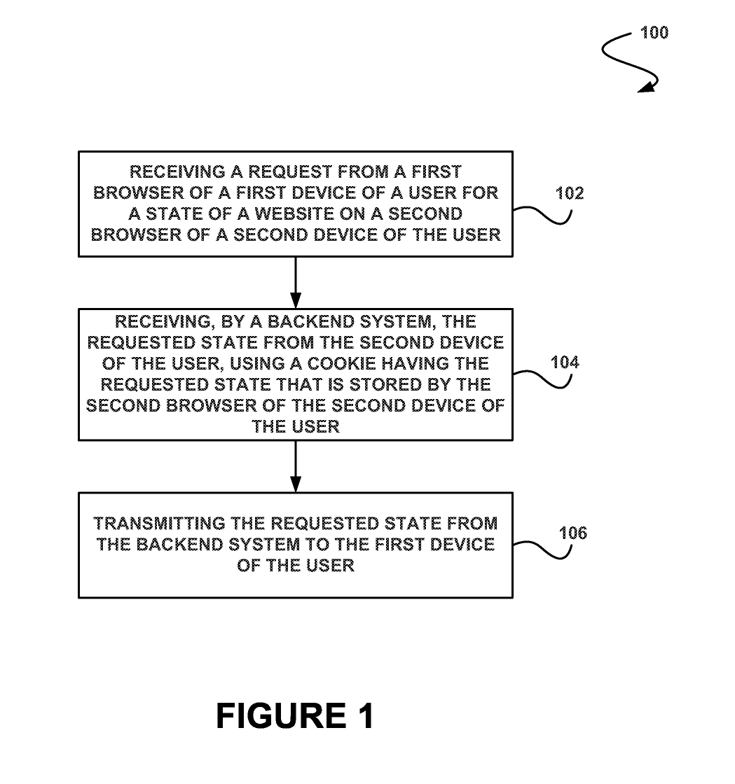

FIG. 1 illustrates a method 100 for transferring a website state across user devices using a cookie, in accordance with an embodiment. It should be noted that the present method 100 may be performed by a backend system, as described in more detail below. For example, the backend system may be separate from the user devices, and may optionally be a portion of the multi-tenant on-demand database system mentioned above.

As shown in operation 102, a request is received from a first browser of a first device of a user, where the request is for a state of a website on a second browser of a second device of the user. In the context of the present description, the first and second devices of the user may be any type of devices capable of being used by a user to access a website via a browser. Thus, it should be noted that the first and second devices may each include a browser connected to a network (e.g. the Internet) which is utilized for accessing the website. For example, the first and second devices of the user may each be a desktop computer, and/or a mobile device such as a tablet device, mobile phone, etc.

As noted above, a state of a website on a second browser of the second device is requested by a first browser of the first device, The state may be a last state of a browsing session with the website held by the second browser of the second device. For example, the state may be a view of the website last displayed via the second browser of the second device. In other optional embodiments, the state may be a section (e.g. page, tab, etc,) of the website last accessed by the user via the second browser of the second device, data entered by the user in the section of the website last accessed by the user via the second browser of the second device, a configuration of a shopping cart of the website on the second browser of the second device (e.g. items in the shopping cart), etc.

To this end, the first browser of the first device may request the state of the website on the second browser of the second device. Additionally, as shown in operation 104, the requested state is received by a backend system from the second device of the user, utilizing a cookie having the requested state that is stored by the second browser of the second device of the user. In other words, the second browser of the second device may store the cookie having the state of the website on the second browser of the second device, The cookie may then be utilized to provide the state of the website to the backend system, when the first browser of the first device requests such state.

Further, as shown in operation 106, the requested state is transmitted from the backend system to the first device of the user. Thus, in the present embodiment, when the first browser of the first device requests the state of the website on the second browser of the second device, the requested state is received by the backend server from the second device, and the backend server then transmits the requested state to the first device. This may allow the first device to present, on the first browser, the state of the website on the second browser of the second device, such that the user may be capable of accessing the same browsing state for a website across the first and second devices.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

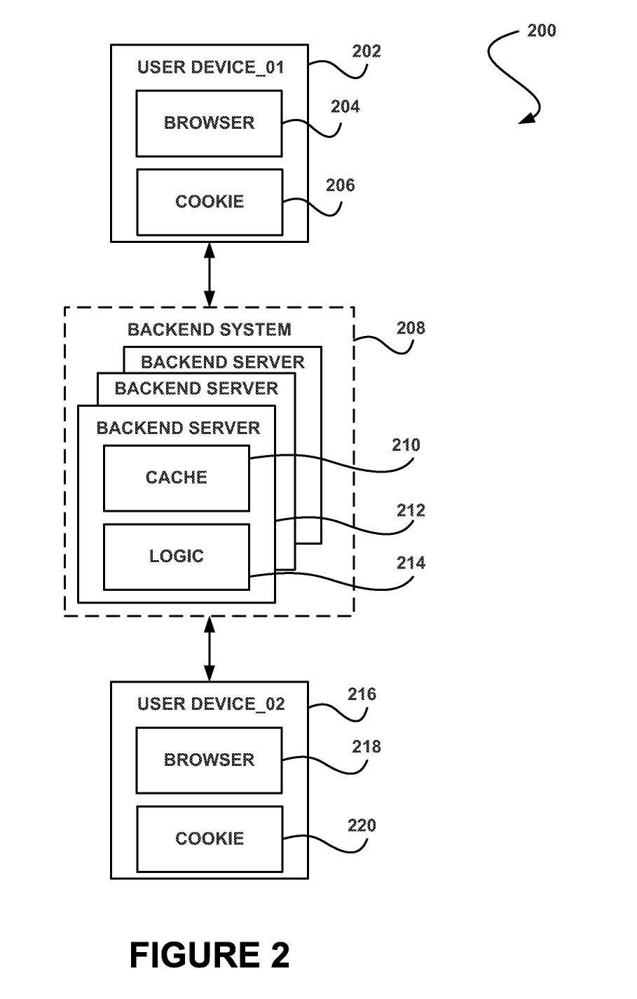

FIG. 2 illustrates a system 200 for transferring a website state across user devices using a cookie, in accordance with an embodiment, As an option, the present system 200 may be implemented to carry out the method 100 of FIG. 1. Of course, however, the system 200 may be implemented in any desired environment. It should also be noted that the aforementioned definitions may apply during the present description.

As shown, a first user device 202 includes a respective first browser 204 and first cookie 206. For a browsing session between the first browser 204 and a website, the first user device 202 stores the cookie 206 having a current (or last known) state of the browsing session. Similarly, a second user device 216 includes a respective second browser 218 and second cookie 220. For a browsing session between the second browser 218 and the website, the second user device 216 stores the cookie 220 having a current (or last known) state of the browsing session. It should be noted that each of the first user device 202 and the second user device 216 may store a respective cookie 206, 220 for each browsing session with a different website, such that a different cookie may store a current (or last known) state of the browsing session with the associated website.

Also included is a backend system 208 which consists of one or more backend servers 212. Each backend server has a cache 210 (or other memory) and logic 214 (e.g. code, etc.), as shown. Thus, in an embodiment where the backend system 208 includes multiple backend servers 212, the backend system 208 may provide a distributing caching system. The backend system 208 communicates with the first user device 202 and the second user device 216 via one or more networks (not shown). Thus, the first user device 202 and the second user device 216 may not necessarily be located on a same network, but instead may be located on different networks (e.g. of different network service providers) which are accessible to the backend system 208.

In an embodiment, the first browser 204 of the first user device 202 accesses a website. For example, the user may initiate a first browsing session with the website using the first browser 204 of the first user device 202 (e.g. by logging into the website using the first browser 204). A state of the website on the first browser 204 of the first user device 202 is tracked to store a latest state in the cookie 206 on the first user device 202.

The second browser 218 of the second user device 216 may subsequently request the state of the website on the first browser 204 of the first user device 202. For example, the user may initiate a second browsing session with the website using the second browser 218 of the second user device 216 (e.g. by logging into the website using the second browser 218), and may then request that the second browsing session mimic the state of the first browsing session with the website on the first browser 204 of the first user device 202. This request may be made to the backend system 208, and not necessarily directly to the first user device 202,

in response to the request, the logic 214 of the backend system 208 may receive the state from the cookie 206 on the first user device 202, and may store such state in the cache 210 of the backend system 208. The logic 214 of the backend system 208 may then transmit the state stored in the cache 210 to the second user device 216. In this way, the second user device 216 may present the state in the second browser 218 of the second user device 216, and may further store such state in the cookie 220 of the second user device 216. Optionally, by only using the backend system 208 to transfer the website state information from the first user device 202 to the second user device 216 when the user has logged into the website at both the first user device 202 to the second user device 216, security of the website may be maintained (e.g. by avoiding transferring such website state information to a device when the user has not logged into the website on that device).

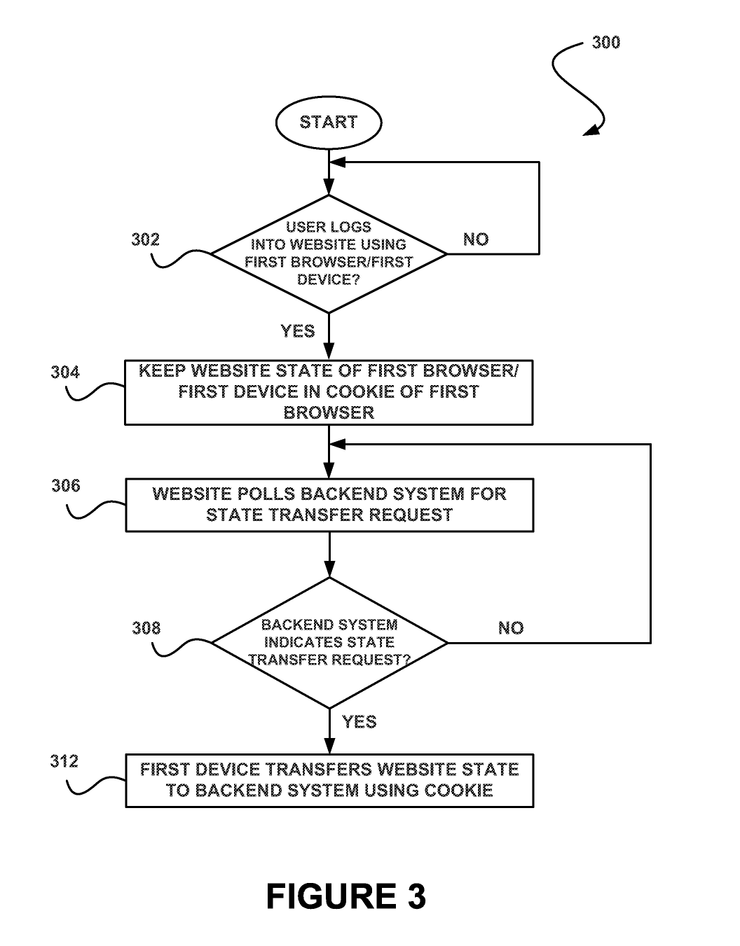

FIG. 3 illustrates a method 300 for using a first device of a user to initiate a browsing session with a website, in accordance with an embodiment. As an option, the method 300 may be carried out in the context of the system 200 of FIG. 2. For example, the method 300 may be carried out by the first user device 202 of FIG. 2. Of course, however, the method 300 may be carried out in any desired environment. It should also be noted that the aforementioned definitions may apply during the present description.

As shown in decision 302, it is determined whether a user logs into a website using a first browser of a first device. If it is determined that the user does not log into the website, the method 300 continues to wait for a determination that the user has logged into a website. In other words, the method 300 may only continue once the user logs into a website using the first browser of the first device, for example, and thus establishes a first browsing session with the website.

When it is determined that the user logs into a website using the first browser of the first device, a state of the website on the first browser of the first device is stored in a cookie (note operation 304). Of course, the state of the website on the first browser of the first device may be stored in the cookie in response to the user initiating the first browsing session with the website in any desired manner. As the user interacts with the website via the first browser of the first device, such as by viewing different portions (e.g. webpages, tabs, etc.) of the website, entering data in the website, adding items to or removing items from a shopping cart of the website, etc., the cookie may be updated to store a last known (i.e. latest) state of the website on the first browser of the first device.

Furthermore, as shown in operation 306, the website polls a backend system for any request to transfer the state of the website stored in the cookie. In the present embodiment, the website polling may be performed by the first browser of the first device. For example, the website polling may be performed by the first browser of the first device while the first browser of the first device holds the browsing session with the website. The polling may be performed at a periodic (e.g. regular) interval. This interval may be kept small (e.g., every 2 seconds) to reduce a wait time by another device which may have requested the state of the website stored in the cookie.

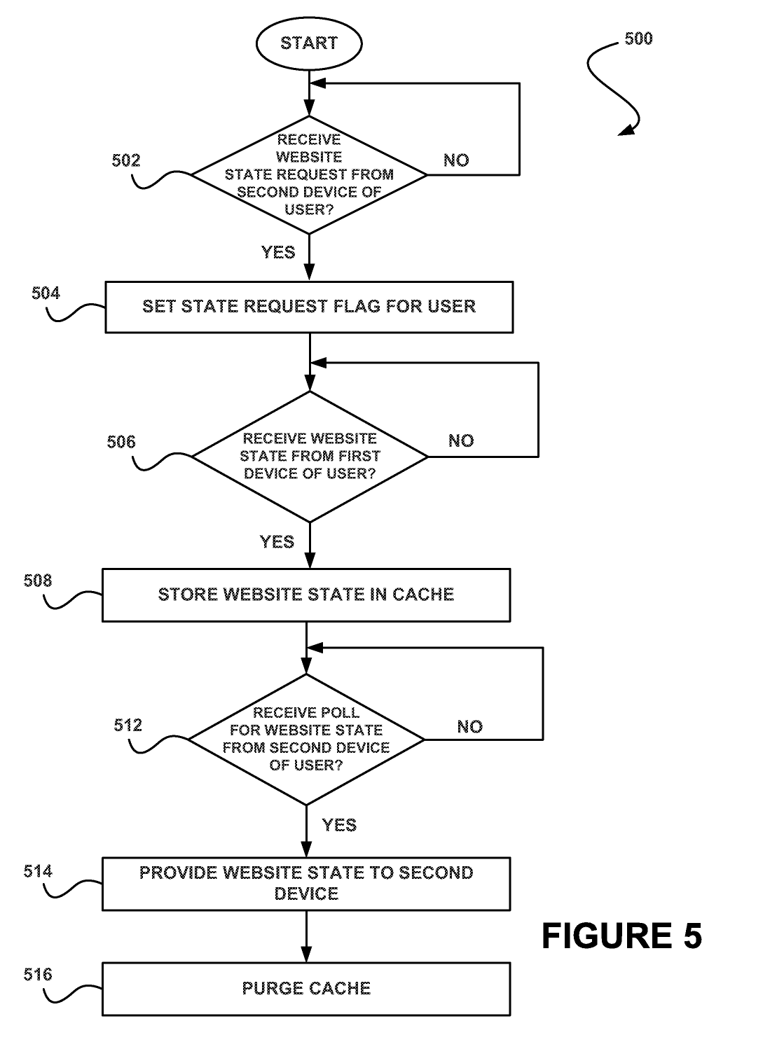

According y, from the polling it is determined in decision 308 whether the backend system indicates a request to transfer the state of the website. This indication may be provided via a flag set by the backend system, as described in more detail below with reference to FIG. 5. If it is determined from the polling that the backend system does not indicate a request to transfer the state of the website, the method 300 continues with the polling described in operation 306.

However, once it is determined from the polling that the backend system does indicate a request to transfer the state of the website, the first device transfers the state of the website to the backend system using the cookie. Note operation 312. For example, the state stored by the cookie may be transmitted to the backend system by the first device.

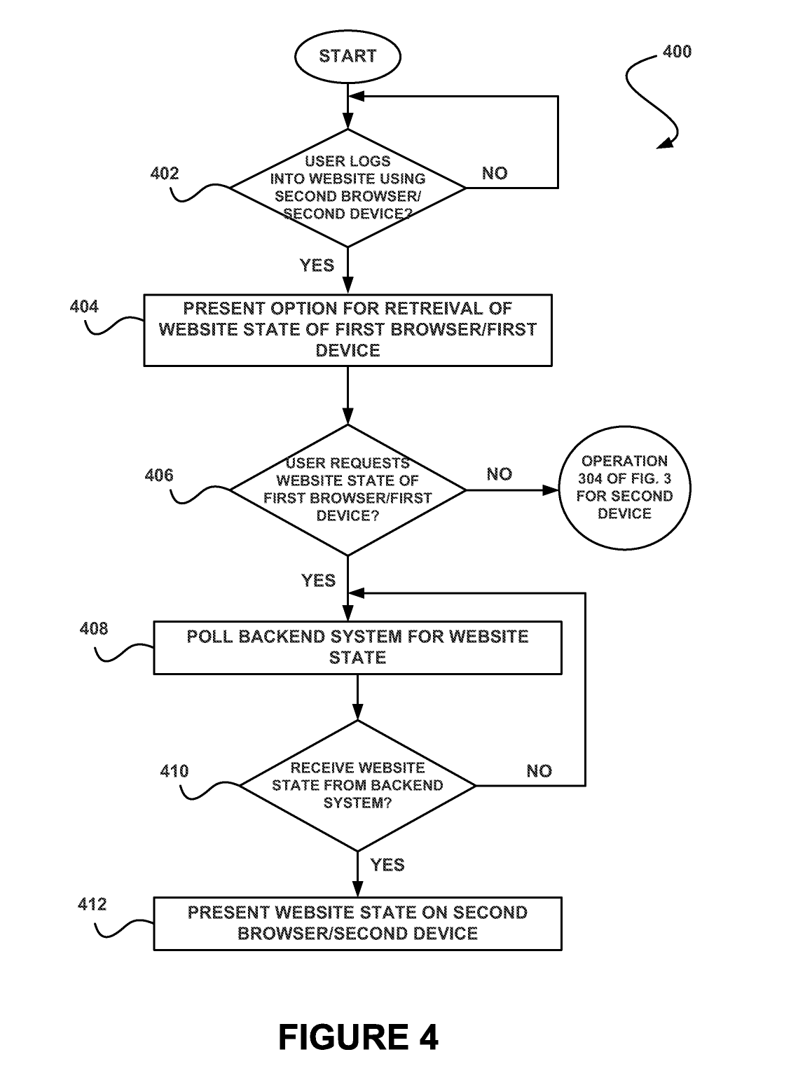

In this way, the requested state may be provided to the backend system at the initiative of the first device, namely responsive to the polling by the first device. Further, as noted above, the state may be provided to the backend system as a response to the request from another device (i.e., a second browser of a second device of the user) for the state of the website on the first browser of the first device. This request will be described in more detail below with reference to FIG. 4.

FIG. 4 illustrates a method 400 for using a second device of the user to access the browsing session of the first device of the user, in accordance with the method of FIG. 3. As an option, the method 400 may be carried out in the context of the system 200 of FIG. 2. For example, the method 400 may be carried out by the second user device 216 of FIG. 2. Of course, however, the method 400 may be carried out in any desired environment. It should also be noted that the aforementioned definitions may apply during the present description.

As shown, it is determined in decision 402 whether the user logs into the website using a second browser of a second device. If it is determined that the user does not log into the website, the method 400 continues to wait for a determination that the user has logged into a website. In other words, the method 400 may only continue once the user logs into the website using the second browser of the second device (i.e. separate from the first device described above with reference to FIG. 3). This login to the website using the second browser of the second device may establish a second browsing session with the website which is different from the first browsing session established with the website via the first browser of the first device of the user.

When it is determined that the user logs into the website using the second browser of the second device, an option is presented for retrieval of a state of the website on the first browser of the first device (note operation 404). The option may be presented as a pop-up or other graphical user interface (GUI) associated with the website, and thus may be presented via the second browser of the second device. The option may include text, such as “We have determined that you were in the middle of performing some tasks on a different machine, would you like to restart where you left?”, as well as a button for the user to select to retrieve the state of the website on the first browser of the first device, and optionally a button for the user to select to not retrieve the state of the website on the first browser of the first device such that the second browsing session instead proceeds at an entry page of the website without reference to the state of the website on the first browser of the first device).

it is determined in decision 406 whether the user requests, via the option presented in operation 404, the state of the website on the first browser of the first device. If the user does not request the state of the website on the first browser of the first device, the method 400 proceeds to operation 304 of FIG. 3 for the second browser/second device. Thus, as noted above, the second browser of the second device may proceeds at an entry page of the website without reference to the state of the website on the first browser of the first device.

However, if the user does request the state of the website on the first browser of the first device, the backend system is polled for the state of the website on the first browser of the first device (note operation 308). As noted above, the polling may be performed by the second. browser of the second device (e.g. at a periodic interval, etc.). Further, as described below with reference to FIG. 5, the polling may result in the backend system setting a flag for indicating that the state of the website on the first browser of the first device has been requested.

It is then determined in decision 410 whether the state of the website on the first browser of the first device has been received from the backend system. For example, when the second device first polls the backend system for the state of the website on the first browser of the first device, the backend system may not yet have the requested state. Instead, the aforementioned flag may be set, which may indicate to the first device that the state has been requested. When the first device identifies the flag (e.g. from polling performed by the first device, as described above with reference to FIG. 3), the first device may send the requested state to the backend system. Upon a subsequent polling by the second device for the state, the second device may receive the state from the backend system.

Optionally, once the user requests the state of the website on the first browser of the first device, the user may be presented with an indicator that the retrieval of the state is occurring. For example, text may be displayed to the user on the second browser of the second device noting the retrieval, such as “Transferring your data.”, and this text may be removed from display when the state has been retrieved for presentation thereof (i.e. noted below with respect to operation 412).

If it is determined that the state of the website on the first browser of the first device has not been received from the backend system, the method 400 continues to the polling of operation 408. Once it is determined that the state of the website on the first browser of the first device has been received, the state of the website is presented on the second browser of the second device, as shown in operation 412. In this way, the user may continue the browsing session from the first browser of the first device on the second browser of the second device.

FIG. 5 illustrates a method 500 for using a backend system to facilitate the sharing of browser information across user devices, in accordance with the methods of FIGS. 3-4. As an option, the method 500 may be carried out in the context of the system 200 of FIG. 2. For example, the method 500 may be carried out by the backend system 208 of FIG. 2. Of course, however, the method 500 may be carried out in any desired environment. It should also be noted that the aforementioned definitions may apply during the present description.

As shown, it is determined in decision 502 whether a request for the state of the website on the first browser of the first device of the user has been received from the second device of the user. For example, the request may be received with reference to operation 408 of FIG. 4. If it is determined that the request has not been received, the method 500 continues to wait for a determination that the request has been received. In other words, the method 500 may only continue once a request for the state of the website on the first browser of the first device of the user has been received from the second device of the user.

When it is determined that the request has been received, a flag is set for the user, as shown in operation 504. The flag may be specific to the user and the website, in one embodiment. Of course, while a flag is described herein, it should be noted that the backend system may use any desired indicator for making it apparent that a request for the state of the website on the first browser of the first device of the user has been received.

It is further determined in decision 506 whether the state of the website has been received from the first device. If it is determined that the state has not been received, the method 500 continues to wait for the state to be received. Once it is determined that the state has been received, the state is stored in cache of the backend system, as shown in operation 508.

Still yet, it is determined in decision 512 whether a poll for the state has been received from the second device. If it is determined that the poll for the state has not been received from the second device, the method 500 continues to wait for such a poll to be received. Once it is determined that the poll for the state has been received from the second device, the state is provided to the second device (note operation 514). For example, the second device may read the state of the website on the first browser of the first device from the cache of the backend system.

As shown in operation 516, the state may then be purged from the cache. In other words, the state of the website on the first browser of the first device may be purged from the cache of the backend system in response to transmission of the state from the backend system to the second device of the user. This may minimize the amount of storage required by the backend system to store website state information being requested between any number of devices.

### System Overview

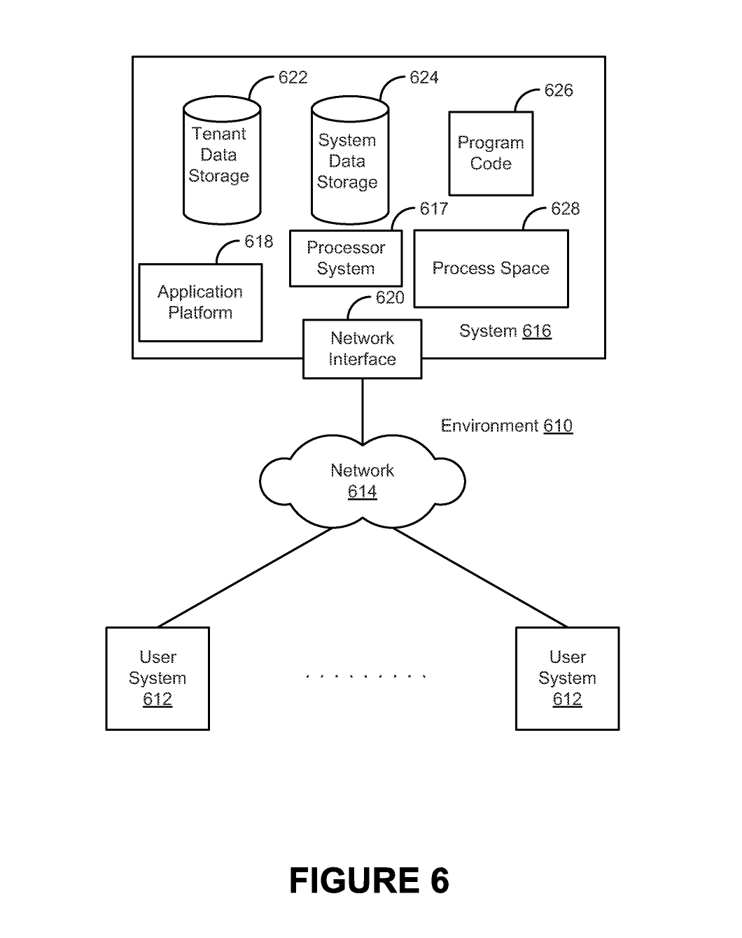

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

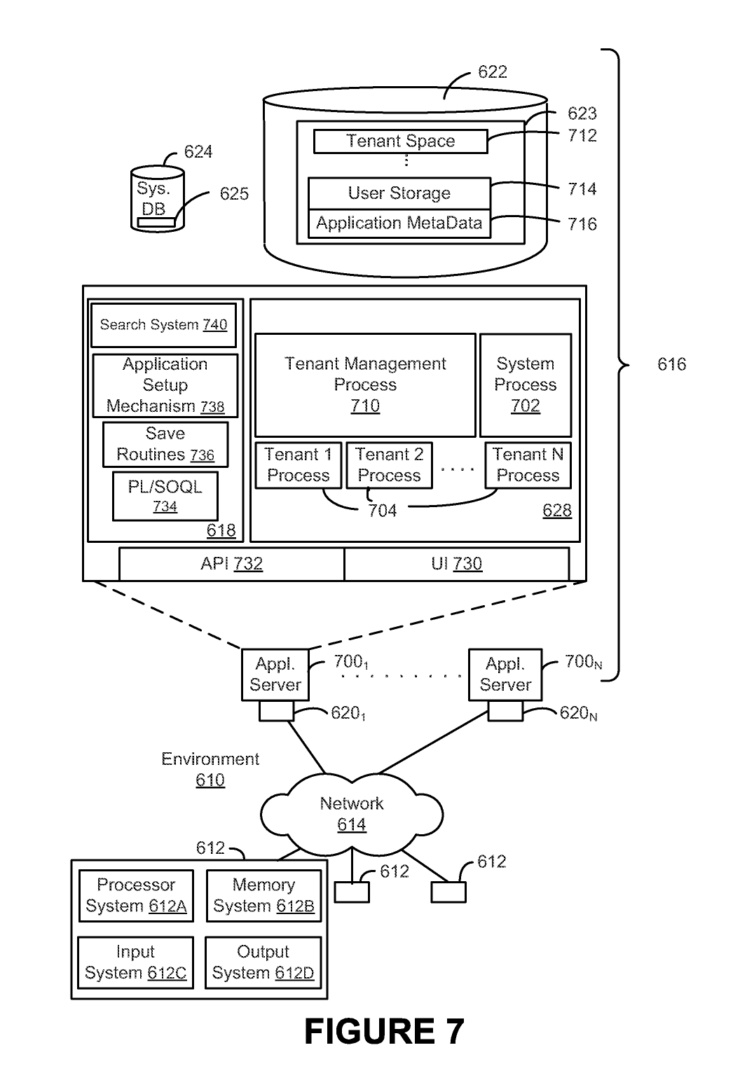

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS)Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRNA application, For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks, However, it should be understood that other networks can be used instead of the Internet, such as an intranet, extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDRMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant. data storage 622, tenant. data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors, Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. As an option, the application platform 618 may further include a search system 640. Invocations to such applications may be coded using PL/SOQL 734 that provides a programming language style interface extension to API 732. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700, Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method, the method comprising:
receiving a request from a first browser of a first device of a user for a state of a website on a second browser of a second device of the user;
receiving, by a backend system, the requested state from the second device of the user, utilizing a cookie having the requested state that is stored by the second browser of the second device of the user; and
transmitting the requested state from le backend system to the first device of the user.

2. The computer program product of claim 1, wherein the user initiated a first browsing session with the website using the second browser of the second device.

3. The computer program product of claim 2, wherein the first browsing session is initiated by the user logging into the website using the second browser of the second device.

4. The computer program product of claim 2, wherein the state of the website on the second browser of the second device is stored in the cookie in response to the user initiating the first browsing session with the website using the second browser of the second device.

5. The computer program product of claim 2, wherein the request for the state of the website on the second browser of the second device is requested by the first browser of the first device in response to the user initiating a second browsing session with the website using the first browser of the first device.

6. The computer program product of claim 5, wherein the second browsing session is initiated by the user logging into the website using the first browser of the first device.

7. The computer program product of claim 6, wherein the request is further received in response to the user selecting an option, via the first browser of the first device, to retrieve the state of the website on the second browser of the second device.

8. The computer program product of claim 7, wherein the option is presented upon the user logging into the website using the first browser of the first device.

9. The computer program product of claim 1, wherein the state of the website on the second browser of the second device includes a view of the website last displayed via the second browser of the second device.

10. The computer program product of claim 1, wherein the state of the website on the second browser of the second device includes at least one of: a section of the website last accessed by the user via the second browser of the second device, data entered by the user in the section of the website last accessed by the user via the second browser of the second device, and a configuration of a shopping cart of the website on the second browser of the second device.

11. The computer program product of claim 1, wherein the requested state is provided to the backend system at the initiative of the second device of the user.

12. The computer program product of claim 11, wherein the requested state is provided to the backend system as a response to the request from the first browser of the first device for the state of the website on the second browser of the second device.

13. The computer program product of claim 12, further comprising setting a flag for the user by the backend system, in response to the receipt of the request for the state of the website on the second browser of the second device.

14. The computer program product of claim 13, wherein the second device of the user polls the backend system for the request, such that the requested state is received from the second device of the user in response to the polling, based on the flag.

15. The computer program product of claim 1, wherein the requested state is stored in cache of the backend system.

16. The computer program product of claim 15, further comprising purging the requested state from the cache in response to transmission of the requested state from the backend system to the first device of the user.

17. The computer program product of claim 1, wherein the requested state is transmitted from the backend system to the first device of the user in response to the first device polling the backend system for the requested state.

18. The computer program product of claim 1, wherein the requested state is transmitted from the backend system to the first device of the user for presenting, on the first browser of the first device, the state of the website on the second browser of the second device.

19. A method, comprising:
receiving a request from a first browser of a first device of a user for a state of a website on a second browser of a second device of the user;
receiving, by a backend system, the requested state from the second device of the user, utilizing a cookie having the requested state that is stored by the second browser of the second device of the user; and
transmitting the requested state from the backend system to the first device of the user.

20. An apparatus, comprising:
a processor for:
receiving a request from a first browser of a first device of a user for a state of a website on a second browser of a second device of the user;
receiving, by a backend system, the requested state from the second device of the user, utilizing a cookie having the requested state that is stored by the second browser of the second device of the user; and
transmitting the requested state from the backend system to the first device of the user.

21. A method for transmitting code, comprising:
transmitting code for receiving a request from a first browser of a first device of a user for a state of a website on a second browser of a second device of the user;
transmitting code for receiving, by a backend system, the requested state from the second device of the user, utilizing a cookie having the requested state that is stored by the second browser of the second device of the user; and
transmitting code for transmitting the requested state from the backend system to the first device of the user.
